(19) United States
(12) Patent Application Publication
(10) Pub. No.: US 2025/0210744 A1
(43) Pub. Date: Jun. 26, 2025

(54) POWER SUPPLY DEVICE

(71) Applicant: TOYOTA JIDOSHA KABUSHIKI KAISHA, Toyota-shi (JP)

(72) Inventor: Hajime SHIMIZU, Gotemba-shi (JP)

(73) Assignee: TOYOTA JIDOSHA KABUSHIKI KAISHA, Toyota-shi (JP)

(21) Appl. No.: 18/829,520

(22) Filed: Sep. 10, 2024

(30) Foreign Application Priority Data
Dec. 26, 2023 (JP) 2023-218841

(51) Int. Cl. H01M 10/63; H01H 47/22; H01M 10/613; H01M 10/625; H01M 10/6556; H01M 10/6568

(52) U.S. Cl. CPC H01M 10/63; H01M 10/613; H01M 10/625; H01M 10/6556; H01M 10/6568; H01H 47/22; H01M 2220/20

(57) ABSTRACT

A power supply device that supplies power to an apparatus, includes: a battery pack including a battery and a cooler made of metal; an insulating oil circuit configured to cool the battery by causing an insulating oil to flow into the cooler; and a controller configured to turn on any one of a first relay and a second relay that supply a current from the battery to a power control device, and to turn off the other to discharge static electricity generated by the flow of the insulating oil to a housing of the apparatus.

### CROSS-REFERENCE TO RELATED APPLICATION

This application claims priority to Japanese Patent Application No. 2023-218841 filed on Dec. 26, 2023. The disclosure of the above-identified application, including the specification, drawings, and claims, is incorporated by reference herein in its entirety.

### BACKGROUND

### 1. Technical Field

The present disclosure relates to a power supply device.

### 2. Description of Related Art

Japanese Unexamined Patent Application Publication No. 2023-504801 (JP 2023-504801 A) discloses a battery pack including a pack case that forms an external appearance, a plurality of battery modules provided inside the pack case and including at least one battery cell, at least one heat insulation member provided between the battery modules, and an energy drain unit. The energy drain unit is spaced apart from the at least one heat insulation member, is connected to any one battery module from among the battery modules, and causes any one battery module to be externally short-circuited at the time of thermal runaway in at least one battery module from among the battery modules.

Furthermore, J P 2023-504801 A also discloses that the energy drain unit includes a relay unit and a resistance unit. The relay unit is connected to the battery cell of any one battery module and is provided to perform on and off operations. The resistance unit is connected to the relay unit and is provided outside the pack case. Moreover, J P 2023-504801 A also discloses that the resistance unit can be filled with an insulating oil, and the insulating oil can cool a resistor within the resistance unit.

### SUMMARY

However, in the related art, for example, there is room for improvement in a case where a temperature of a battery is adjusted by circulating an insulating oil.

The present disclosure provides a technology in which both a reduction in electrostatic charging and safety against a high voltage can be achieved.

A first aspect of the disclosure relates to a power supply device including a battery pack, an insulating oil circuit, and a controller. The power supply device supplies power to an apparatus. The battery pack includes a battery and a cooler made of metal. The insulating oil circuit is configured to cool the battery by causing an insulating oil to flow into the cooler. The controller is configured to turn on any one of a first relay and a second relay that supply a current from the battery to a power control device, and to turn off the other to discharge static electricity generated by the flow of the insulating oil to a housing of the apparatus.

According to the first aspect, both a reduction in electrostatic charging and safety against a high voltage can be achieved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an example of a configuration of an apparatus according to an embodiment;

FIG. 2 is a diagram illustrating an example of a configuration of a power supply device according to the embodiment;

FIG. 3 is a flowchart showing an example of processing performed by a controller according to the embodiment; and

FIG. 4 is a diagram illustrating an example of a hardware configuration of the controller according to the embodiment.

### DETAILED DESCRIPTION OF EMBODIMENTS

The principles of the present disclosure are described with reference to several exemplary embodiments. It should be understood that these embodiments are set forth for purposes of illustration only and that those skilled in the art will assist in understanding and practicing the present disclosure without suggesting limitations on the scope of the present disclosure. The disclosure described herein may be implemented in a variety of ways other than those described below.

In the following description and claims, unless otherwise defined, all technical and scientific terms used herein have the same meaning as commonly understood by one of ordinary skill in the art to which the present disclosure belongs.

Hereinafter, an embodiment of the present disclosure will be described with reference to the drawings.

### Configuration

### Configuration of Apparatus 50

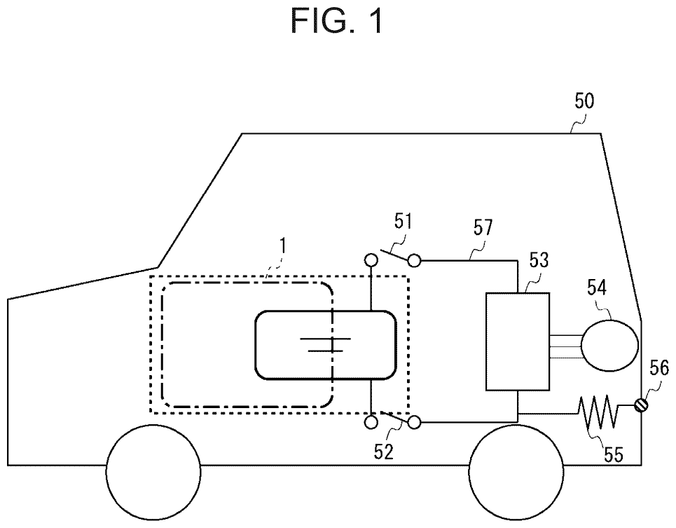

A configuration of an apparatus 50 according to the embodiment will be described with reference to FIG. 1. FIG. 1 is a diagram illustrating an example of the configuration of the apparatus 50 according to the embodiment. In an example of FIG. 1, the apparatus 50 includes a power supply device 1, a first relay 51, a second relay 52, a power control device 53, a drive device (actuator) 54, an insulation resistance 55, a housing (body ground) 56, and an electric circuit 57.

The apparatus 50 may be various kinds of apparatuses such as a vehicle, an air-conditioning facility, a household apparatus, a factory apparatus, and an office apparatus.

The first relay 51 and the second relay 52 switch on and off the electric circuit 57 for supplying power from the power supply device 1 to the power control device 53. In a case where the apparatus 50 is a hybrid electric vehicle, each of the first relay 51 and the second relay 52 may be referred to as, for example, a system main relay (SMR). In the example of FIG. 1, the first relay 51 switches on and off a positive electrode side of the power supply device 1, and the second relay 52 switches on and off a negative electrode side of the power supply device 1.

The drive device 54 is a device that converts electrical energy supplied from the power control device 53 into mechanical motion to operate the apparatus 50. The drive device 54 may include, for example, an electric motor. The drive device 54 may be, for example, a motor generator (MG) as a main power for the hybrid electric vehicle to start and travel. The motor generator assists an engine during acceleration and the like, and regenerates energy during braking to charge a battery.

The insulation resistance 55 reduces a current flow from the electric circuit 57 to which the power supply device 1 is connected to the housing 56 so that anyone who comes in contact with the housing 56 will not receive an electric shock. The housing 56 may be made of a material that is relatively easy to conduct electricity, such as metal. In a case where the apparatus 50 is a vehicle, the housing 56 may be referred to as, for example, a body ground. High-voltage static electricity generated in the power supply device 1 is transmitted from the electric circuit 57 to the housing 56 via the insulation resistance 55, and is released to the ground through tires or the like to which the apparatus 50 is grounded. Configuration of Power Supply Device 1

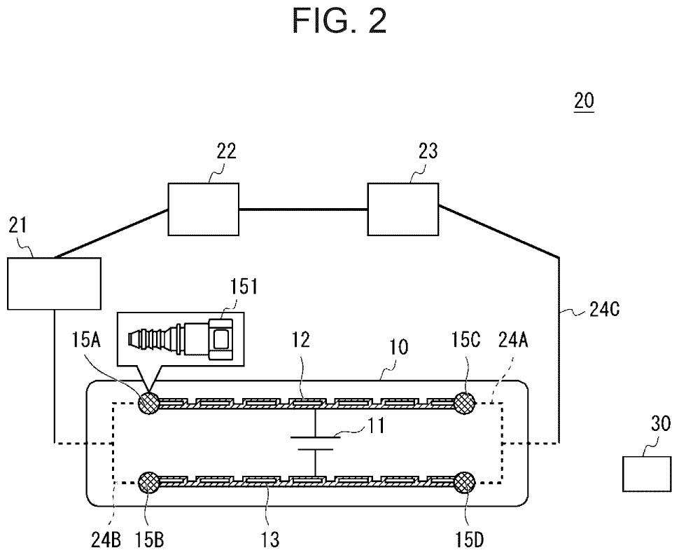

Next, a configuration of the power supply device 1 according to the embodiment will be described with reference to FIG. 2. FIG. 2 is a diagram illustrating an example of the configuration of the power supply device 1 according to the embodiment. In an example of FIG. 2, the power supply device 1 includes a battery pack 10, an insulating oil circuit 20, and a controller 30. The battery pack 10 includes a battery 11, a first cooler 12, a second cooler 13, and resin connectors 15A to 15D. The insulating oil circuit 20 includes a chiller 21, a reservoir tank 22, an oil pump 23, and pipes 24A to 24C.

The battery pack 10 encloses the battery 11, the first cooler 12, the second cooler 13, the resin connectors 15A to 15D, a part of the pipe 24A, and a part of the pipe 24B.

The battery 11 may be, for example, a secondary battery such as a lithium ion battery. The first cooler 12 is a cooling member made of metal or the like provided on a positive electrode side of the battery 11. The first cooler 12 may be in a high voltage state by being brought into contact with a positive electrode of the battery 11 to conduct electricity from the positive electrode. The second cooler 13 is a cooling member made of metal or the like provided on a negative electrode side of the battery 11. The second cooler 13 may be in a high voltage state by being brought into contact with a negative electrode of the battery 11 to conduct electricity from the negative electrode. The first cooler 12 is connected to a first relay 51 side, and the second cooler 13 is electrically connected to a second relay 52 side.

The resin connectors 15A to 15D are resin connectors shaped as shown in an example of an enlarged view 151. Each of the resin connectors 15A to 15D may be used to allow workers who perform assembly (manufacturing) to relatively easily connect a pipe of the first cooler 12 or the second cooler 13 (for example, an internal pipe of the cooler that is a plate made of metal) to the pipe 24A or the pipe 24B.

The insulating oil circuit 20 reduces a temperature of the battery 11 by flowing (circulating) an insulating oil inside the battery pack 10. The insulating oil may be, for example, a liquid having a relatively high insulating property (for example, a volume resistivity of 10⁵ Ωcm or higher). Since the insulating oil has a relatively high insulating property, the insulating oil cannot dissipate static electricity when friction with the pipe occurs due to a flow, and has a characteristic of storing high-voltage static electricity in the insulating oil itself and in the pipe.

The chiller 21 is, for example, a device that cools the insulating oil by an air cooling method or the like. The reservoir tank 22 is, for example, a tank for storing the insulating oil that has expanded due to a temperature increase. The oil pump 23 is a pump that circulates the insulating oil through the insulating oil circuit 20 by extruding the insulating oil.

The pipes 24A to 24C are pipes through which the insulating oil flows. The pipe 24A is a pipe for flowing the insulating oil flows from an outside to an inside of the battery pack 10. The pipe 24B is a pipe for flowing the insulating oil from the inside to the outside of the battery pack 10. As the pipe 24A and the pipe 24B, for example, a member having a volume resistivity equal to or higher than a threshold may be used in order to ensure an insulating property for the first cooler 12 and the second cooler 13, which are components 20 that are subjected to high voltages.

In this case, the pipe 24A and the pipe 24B may be made of, for example, rubber of 10⁸ Ωcm or higher. Accordingly, it is possible to reduce the occurrence of treeing breakdown of the pipe 24A and the pipe 24B due to static electricity. Treeing breakdown is a phenomenon in which a localized high electric field portion in a solid of a resin-insulating material causes gradual propagation of a dendritic breakdown path when an inherent breakdown limit of the solid is exceeded, ultimately leading to perforation breakdown. It is known that treeing breakage occurs in a resin material, but not in a rubber material.

The pipe 24C is a part other than the pipe 24A and the pipe 24B in the pipes of the insulating oil circuit 20. The pipe 24C may be made of, for example, rubber or resin of 10⁷ Ωcm or less, which is relatively easy to conduct static electricity.

The controller 30 may be, for example, a microcomputer such as an electronic control unit (ECU). The controller 30 controls each unit of the apparatus 50.

### Processing

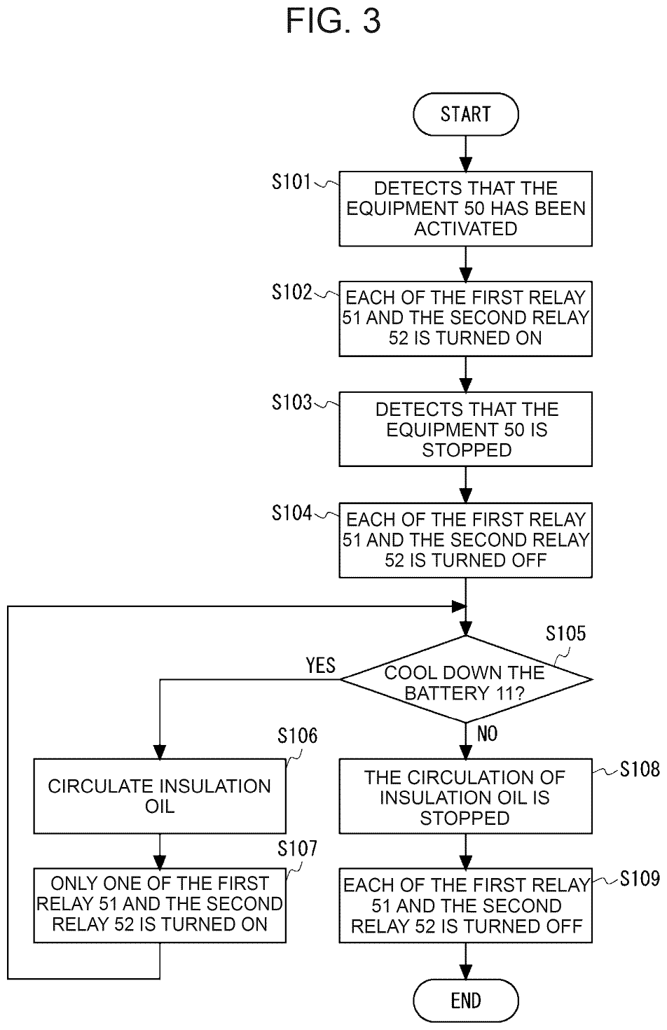

Next, an example of processing of the controller 30 according to the embodiment will be described with reference to FIG. 3. FIG. 3 is a flowchart showing the example of the processing performed by the controller 30 according to the embodiment. Each process in FIG. 3 may be executed in a different order as long as there is no inconsistency.

In S101, the controller 30 detects that the apparatus 50 has been activated by a user or the like. Here, the controller 30 may detect, for example, that a power button or the like of the apparatus 50 has been pressed.

Subsequently, the controller 30 sets each of the first relay 51 and the second relay 52 to ON (S102). As a result, power is supplied from the power supply device 1 to the power control device 53, and the user or the like can operate the drive device 54. In a case where each of the first relay 51 and the second relay 52 is turned on, even in a case where the insulating oil is circulated in the insulating oil circuit 20, static electricity of the resin connectors 15A to 15D is discharged from the housing 56. Therefore, treeing breakdown of the resin connectors 15A to 15D caused by static electricity charged on the resin connectors 15A to 15D is prevented.

Subsequently, the controller 30 detects that the apparatus 50 is stopped by the user or the like (S103). Here, the controller 30 may detect, for example, that the power button or the like of the apparatus 50 has been pressed again.

Subsequently, the controller 30 sets each of the first relay 51 and the second relay 52 to OFF (S104). As a result, the power supply from the power supply device 1 to the power control device 53 is stopped, and the drive device 54 can be stopped (put into a non-operating state).

Subsequently, the controller 30 determines whether or not to cool the battery 11 (S105). Here, for example, the controller 30 may determine that the battery 11 is to be cooled in a case where a temperature around the battery 11 measured by a temperature sensor or the like is equal to or higher than a threshold.

The process of S105 may be performed, for example, at a particular time, such as periodically, during a period from a time when the apparatus 50 is stopped to a particular time (for example, from the apparatus 50 is stopped to a time when a temperature around the battery 11 falls below the threshold).

In a case where the controller 30 determines that the battery 11 is to be cooled (YES in S105), the controller 30 causes the insulating oil to circulate in the insulating oil circuit 20 (S106). Here, the controller 30 may, for example, activate the oil pump 23 to circulate the insulating oil.

Subsequently, the controller 30 turns on any one of the first relay 51 and the second relay 52, turns off the other (S107), and proceeds to the process of S105. As a result, for example, in a case where the battery 11 is cooled when the drive device 54 of the apparatus 50 is not in operation (for example, when the vehicle is parked (stopped)), static electricity of the resin connectors 15A to 15D is discharged from the housing 56 in a state in which no power is supplied to the power control device 53. Therefore, treeing breakdown of the resin connectors 15A to 15D caused by static electricity charged on the resin connectors 15A to 15D is prevented. The static electricity is static electricity caused by friction between the flowing insulating oil and the resin connectors 15A to 15D.

When the controller 30 determines that the battery 11 is not to be cooled (NO in S105), the controller 30 stops the circulation of the insulating oil in the insulating oil circuit 20 (S108). Here, the controller 30 may, for example, stop the oil pump 23.

Subsequently, the controller 30 sets each of the first relay 51 and the second relay 52 to OFF (S109), and ends the processing.

### Example of Sticking of First Relay 51 and Second Relay 52

The controller 30 may inspect whether or not each of the first relay 51 and the second relay 52 is stuck, and in a case where any one of the first relay 51 and the second relay 52 is stuck, may turn off the other. As a result, for example, even in a case where the first relay 51 is stuck to the electric circuit 57 due to a failure or the like and is always on, the second relay 52 can be turned off. Therefore, it is possible to prevent a situation in which both the first relay 51 and the second relay 52 are turned on to cool the battery 11 when the drive device 54 is not in operation and power is supplied to the power control device 53 and is thus wasted.

For example, in a case where a voltage of the electric circuit 57 measured in a state in which the first relay 51 is controlled to be turned off and the second relay 52 is controlled to be turned on is equal to or higher than a threshold, the controller 30 may determine that the first relay 51 is stuck. Alternatively, for example, in a case where the voltage of the electric circuit 57 measured in a state in which the first relay 51 is controlled to be turned on and the second relay 52 is controlled to be turned off is equal to or higher than the threshold, the controller 30 may determine that the second relay 52 is stuck.

In a case where one relay is stuck, when a voltage of static electricity charged on the cooler connected to the other relay is equal to or higher than a threshold, the controller 30 may turn on the other relay. As a result, for example, in a case where static electricity on a side of the positive electrode side and the negative electrode side of the battery 11 that is not on a stuck relay side is not released, the static electricity can be discharged even in a case where the drive device 54 is activated by turning on both relays. Here, the controller 30 may measure the voltage of the static electricity by a sensor or the like.

In this case, in a case where the first relay 51 is stuck, when the voltage of the static electricity charged on the second cooler 13 connected to the second relay 52 side is equal to or higher than the threshold, the controller 30 may turn on the second relay 52. Alternatively, in a case where the second relay 52 is stuck, when the voltage of the static electricity charged on the first cooler 12 connected to the first relay 51 side is equal to or higher than the threshold, the controller 30 may turn on the first relay 51.

### Other

In a case where a component subjected to a high voltage is made of a material having a relatively low volume resistivity, it is difficult to secure the insulating property. On the other hand, in a case where a component subjected to a high voltage is made of a material having a relatively high volume resistivity and the component is cooled with oil, the component is more likely to be charged with static electricity.

According to the present disclosure, it is possible to secure a path for discharging static electricity of the resin connector used for connecting the cooler and the rubber pipe in the battery pack 10. Therefore, both a reduction in electrostatic charging and safety against a high voltage can be achieved.

### Hardware Configuration

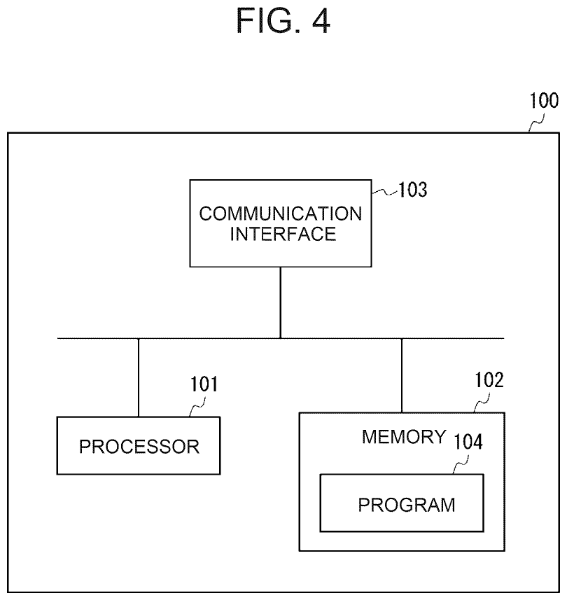

FIG. 4 is a diagram illustrating an example of a hardware configuration of the controller 30 according to the embodiment. In an example of FIG. 4, the controller 30 (computer 100) includes a processor 101, a memory 102, and a communication interface 103. These units may be connected by a bus or the like. The memory 102 stores at least a part of a program 104. The communication interface 103 includes an interface needed for communication with other network elements.

When the program 104 is executed by cooperation of the processor 101, the memory 102, and the like, the computer 100 performs processing of at least a part of the embodiment of the present disclosure. The memory 102 may be of any kind. The memory 102 may be a non-transitory computer-readable storage medium as a non-limiting example. The memory 102 may also be implemented using any suitable data storage technology, such as semiconductor-based memory devices, magnetic memory devices and systems, optical memory devices and systems, fixed memory, and removable memory. Although one memory 102 is shown in the computer 100, there may be several physically different memory modules in the computer 100. The processor 101 may be of any kind. The processor 101 may include one or more of a general-purpose computer, a dedicated computer, a microprocessor, a digital signal processor (DSP), and, as a non-limiting example, a processor based on a multi-core processor architecture. The computer 100 may include a plurality of processors, such as application-specific integrated circuit chips, which are temporally dependent on a clock that synchronizes a main processor.

The embodiment of the present disclosure may be implemented in hardware or dedicated circuitry, software, logic, or any combination thereof. Some aspects may be implemented in hardware, while other aspects may be implemented in firmware or software that can be executed by a controller, a microprocessor, or other computing devices.

The present disclosure also provides at least one computer program product tangibly stored on a non-transitory computer-readable storage medium. The computer program product includes computer-executable instructions, such as instructions contained in program modules, that are executed by a device on a target real or virtual processor to perform the processes or methods of the present disclosure. The program modules include routines, programs, libraries, objects, classes, components, data structures, and the like that perform particular tasks or implement particular abstract data types. Functionality of the program modules may be combined or split between the program modules as desired in various embodiments. Machine-executable instructions of the program modules may be executed in a local or distributed device. In a distributed device, the program modules can be disposed on both local and remote storage media.

Program codes for performing the methods of the present disclosure may be written in any combination of one or more programming languages. These program codes are provided to a processor or controller of a general-purpose computer, a dedicated computer, or other programmable data processing devices. When the program codes are executed by the processor or the controller, functions or operations in the flowchart or in the block diagram to be implemented are performed. The program codes are executed entirely on a machine, partially on the machine, as a stand-alone software package, partially on the machine and partially on a remote machine, or entirely on the remote machine or on a server.

The program can be stored using various kinds of non-transitory computer-readable media and supplied to a computer. The non-transitory computer-readable media include various kinds of tangible recording media. Examples of the non-transitory computer-readable media include magnetic recording media, magneto-optical recording media, optical disk media, and semiconductor memories. Examples of the magnetic recording media include flexible disks, magnetic tapes, and hard disk drives. Examples of the magneto-optical recording media include magneto-optical disks. Examples of the optical disk media include Blu-ray discs, compact disc read-only memories (CD-ROM), CD-recordables (CD-R), and CD-rewritables (CD-RW). Examples of the semiconductor memories include solid-state drives, mask ROMs, programmable ROMs (PROM), erasable PROMs (EPROM), flash ROMs, and random-access memories (RAM). The program may also be supplied to the computer by various kinds of transitory computer-readable media. Examples of the transitory computer-readable media include electrical signals, optical signals, and electromagnetic waves. The transitory computer-readable media can supply the program to the computer via a wired communication path such as an electric wire and an optical fiber, or a wireless communication path.

### Modification Example

The controller 30 may be a device included in one housing, but the controller 30 of the present disclosure is not limited to this. Each unit of the controller 30 may be realized by, for example, cloud computing constituted by one or more computers.

The present disclosure is not limited to the above-described embodiments, and can be modified as appropriate without departing from the gist.

What is claimed is:

1. A power supply device that supplies power to an apparatus, the power supply device comprising:
a battery pack including a battery and a cooler made of metal;
an insulating oil circuit configured to cool the battery by causing an insulating oil to flow into the cooler; and
a controller configured to turn on any one of a first relay and a second relay that supply a current from the battery to a power control device, and to turn off the other to discharge static electricity generated by the flow of the insulating oil to a housing of the apparatus.

2. The power supply device according to claim 1, wherein, in a case where the battery is cooled by the insulating oil circuit when a drive device of the apparatus is not in operation, the controller turns on any one of the first relay and the second relay, and turns off the other.

3. The power supply device according to claim 1, wherein:
a pipe of the cooler and a pipe made of rubber for flowing the insulating oil to an outside of the battery pack are connected by a connector made of resin; and
the static electricity is static electricity caused by friction between the flowing insulating oil and the connector.

4. The power supply device according to claim 1, wherein the controller inspects whether or not each of the first relay and the second relay is stuck, and in a case where any one of the first relay and the second relay is stuck, turns off the other.

5. The power supply device according to claim 4, wherein:
the cooler includes a first cooler connected to a first relay side and a second cooler connected to a second relay side; and
in a case where the first relay is stuck, and when a voltage of the static electricity charged on the second cooler is equal to or higher than a threshold, the controller turns on the second relay.
